(19) United States
(12) Patent Application Publication
(10) Pub. No.: US 2019/0066285 A1
(43) Pub. Date: Feb. 28, 2019

(54) IMAGE INSPECTION APPARATUS, IMAGE INSPECTION METHOD, AND IMAGE INSPECTION PROGRAM

(71) Applicant: FUJITSU LIMITED, Kawasaki-shi (JP)

(72) Inventor: Hiroki Shibuya, Kawasaki (JP)

(73) Assignee: FUJITSU LIMITED, Kawasaki-shi (JP)

(21) Appl. No.: 16/057,340

(22) Filed: Aug. 7, 2018

(30) Foreign Application Priority Data
Aug. 23, 2017 (JP) 2017-160652

(51) Int. Cl. G06T 7/00; G06K 9/62

(52) U.S. Cl. CPC G06T 7/001; G06T 2207/20081; G06K 9/6227; G06K 9/6257

(57) ABSTRACT

An image inspection apparatus includes a processor configured to: determine whether a second image depicts defectiveness or non-defectiveness, based on a first evaluation criterion learned by using a first evaluation parameter of a first image, and when the processor determines that the second image depicts defectiveness, determine whether the second image depicts defectiveness or non-defectiveness, based on a second evaluation criterion learned by using a second evaluation parameter.

### CROSS-REFERENCE TO RELATED APPLICATION

This application is based upon and claims the benefit of priority of the prior Japanese Patent Application No. 2017-160652, filed on Aug. 23, 2017, the entire contents of which are incorporated herein by reference.

### FIELD

The embodiments discussed herein are related to an image inspection apparatus, an image inspection method, and a computer-readable recording medium having stored therein an image inspection program.

### BACKGROUND

There exist techniques to use images for learning to cause a machine-learning device to perform machine learning based on specific evaluation parameters, thus causing the machine-learning device to determine whether an image depicts defectiveness or non-defectiveness (for example, see Japanese Laid-open Patent Publication No. 2014-94794).

When a machine-learning device that has performed learning is caused to determine target images, images depicting non-defectiveness tend to be appropriately determined. However, some of the images determined to be images depicting defectiveness would normally be determined to be images depicting non-defectiveness. In such a case, if the machine-learning device is caused to perform relearning so that images depicting non-defectiveness that have been incorrectly determined to be images depicting defectiveness are correctly determined to be images depicting non-defectiveness, images that have been correctly determined to be images depicting defectiveness before the relearning might be incorrectly determined to be images depicting non-defectiveness.

### SUMMARY

According to an aspect of the embodiments, an image inspection apparatus includes a processor configured to determine whether a second image depicts defectiveness or non-defectiveness, based on a first evaluation criterion learned by using a first evaluation parameter of a first image, and when the processor determines that the second image depicts defectiveness, determine whether the second image depicts defectiveness or non-defectiveness, based on a second evaluation criterion learned by using a second evaluation parameter.

The object and advantages of the invention will be realized, and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1A illustrates an example in which a mounting component is mounted on a package, and FIG. 1B illustrates an image (upper side), which is acquired when a camera images a location near a ridgeline of the mounting component, and a schematic diagram (lower side) thereof;

FIGS. 2A to 2E are diagrams illustrating defectiveness determination;

FIGS. 3A to 3F are diagrams illustrating defectiveness determination;

FIGS. 4A to 4C are diagrams illustrating defectiveness determination;

FIG. 5A is a block diagram illustrating a hardware configuration of a machine-learning device of a first embodiment, and FIG. 5B is a functional block diagram of the machine-learning device;

FIG. 6 is a diagram illustrating setting of a first evaluation area;

FIG. 7 is a diagram illustrating a flowchart that is executed when an image inspection apparatus performs image inspection;

FIGS. 8A and 8B are diagrams illustrating training data;

FIG. 9 is a diagram illustrating a flowchart performed parallel to a flowchart in FIG. 7;

FIG. 10 is a diagram illustrating a flowchart representing details of step S13;

FIG. 11 is a diagram illustrating evaluation conditions;

FIG. 12 is a diagram illustrating a distance to a threshold;

FIG. 13 includes diagrams each illustrating the degree of separation between non-defective-product images and defective-product images; and

FIG. 14 is a diagram illustrating an image inspection system.

### DESCRIPTION OF EMBODIMENTS

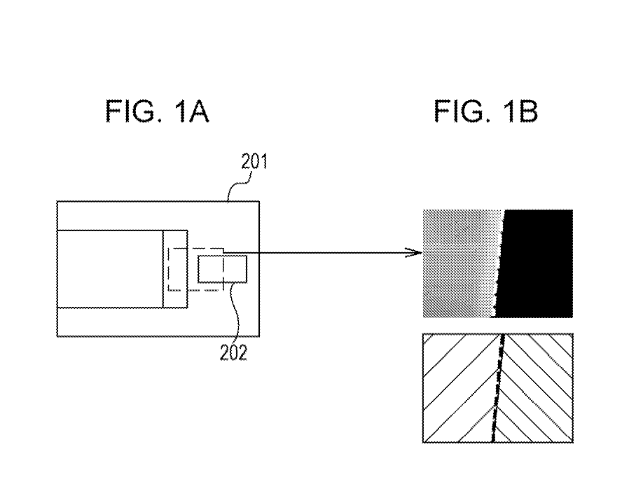

Prior to describing embodiments, image recognition used in a product assembly process will be described. For example, in component mounting in the product assembly process, the position, orientation, and the like of a component are adjusted. In such a case, an image recognition technique is used for detecting the position, orientation, and the like of a component. For example, FIG. 1A illustrates an example in which a mounting component 202 is mounted on a package 201. The mounting component may include an electronic circuit. The package may include a chip package. As illustrated in FIG. 1A, on the package 201, the position, orientation, and the like of the mounting component 202 are adjusted in accordance with the positional relationships with other components. FIG. 1B illustrates an image (upper side), which is acquired when a camera images a location near a ridgeline of the mounting component 202, and a schematic diagram (lower side) thereof. In such a way, recognizing an image of a ridgeline of the mounting component 202 enables the inclination (orientation), a gap (position) between the mounting component and another component, and the like of the mounting component 202 to be measured.

In the upstream process of assembly equipment used in the product assembly process, it is desirable that an image recognition algorithm be developed by using a few sample images. For example, an image recognition algorithm is developed by a technology to automatically generate an image recognition algorithm (machine learning). Making use of this image recognition algorithm enables determination of whether or not an anomaly is depicted in an image acquired in the actual product assembly process. Hereinafter, an image of the state where an anomaly has occurred in a product is referred to as a defective-product image and an image of the state where no anomaly has occurred in a product is referred to as a non-defective-product image.

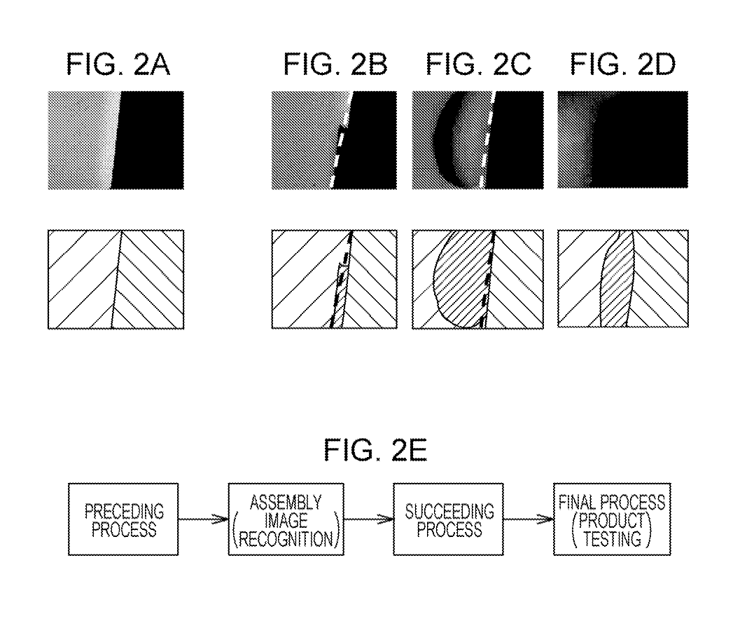

When a product assembly process actually operates to allow mass production to begin, an image having a feature that was not expected at the time of machine learning of an image recognition algorithm is sometimes acquired. For example, FIG. 2A illustrates an example of a non-defective-product image (upper side) acquired during development of an image recognition algorithm, and a schematic diagram (lower side) thereof. This image does not depict foreign matter attachment or a change in the external shape of a product.

In contrast, FIG. 2B illustrates an image (upper side) of the state where edge chipping in the mounting component 202 results in a change in the external shape thereof, and a schematic diagram (lower side) of the image. FIG. 2C illustrates an image (upper side) of the state where, as foreign matter, an adhesive is attached to the mounting component 202, and a schematic diagram (lower side) of the image. FIG. 2D illustrates an image (upper side) of the state where, as foreign matter, an adhesive is excessively applied to the mounting component 202, such that the mounting component 202 is not recognizable, and a schematic diagram (lower side) of the image. Acquiring an image having a feature that was not expected at the time of developing an image recognition algorithm, as illustrated in FIG. 2B to FIG. 2D, might cause an incorrect determination. For example, in some cases, even a non-defective-product image with a small change in the external shape of a product is incorrectly determined to be a defective-product image. Conversely, in some cases, even a defective-product image with a large change in the external shape of a product is incorrectly determined to be a non-defective-product image.

In the case where, as illustrated in FIG. 2E, an incorrect determination is made in a product assembly process, such that poor quality is not discovered, a defective product will flow to the succeeding process. In such a case, for example, poor quality is detected in product testing of the final process. Accordingly, techniques to reduce incorrect determinations are desirable.

Methods to reduce incorrect determinations in image recognition include a technique that determines, prior to image recognition, whether an image of a product in a product assembly process (hereinafter referred to as an assembly-process image) is recognizable. For example, monitoring features of an assembly-process image enables determination of whether the product is defective or non-defective. The features include an average luminance, a luminance distribution, a contrast, frequency information, and the like.

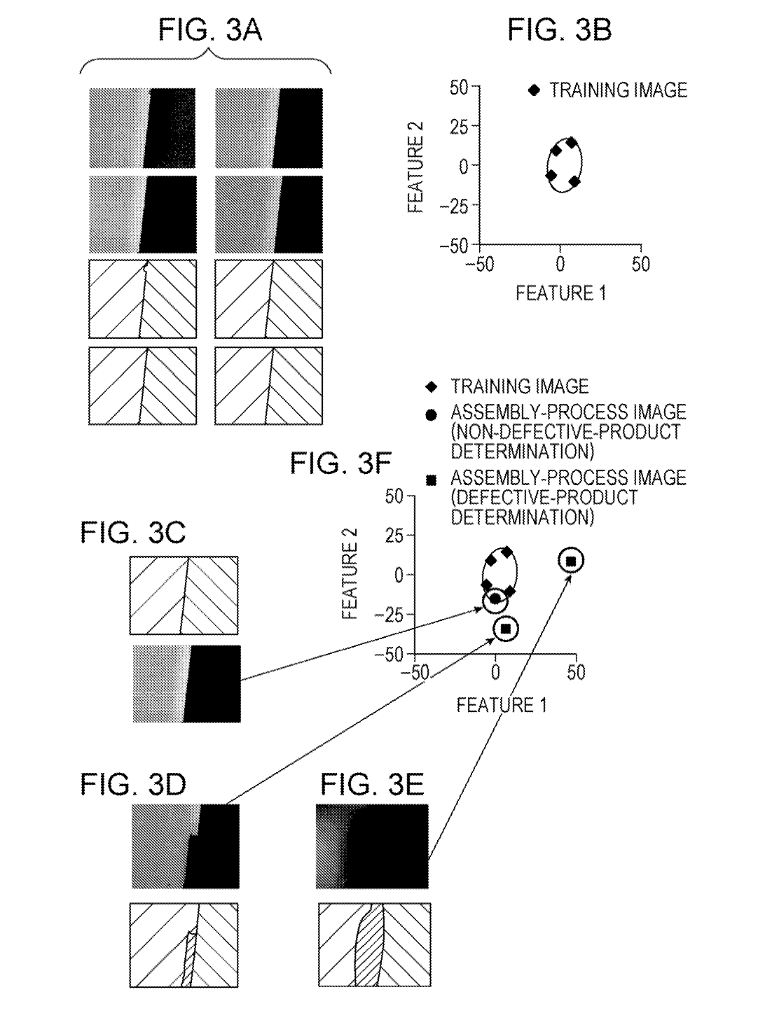

First, an evaluation area is set as an evaluation criterion by using. features of training images. FIG. 3A illustrates training images (upper side) and schematic diagrams (lower side) thereof. Each image in FIG. 3A is a non-defective-product image. FIG. 3B is a diagram illustrating a distribution of training images in the case where a contrast (feature 1) and an average luminance (feature 2) are used as features. Machine learning enables an evaluation area to be set by setting the boundary of a distribution of training images. An assembly-process image having features positioned inside the evaluation area is determined to be a non-defective-product image. An assembly-process image having features positioned outside the evaluation area is determined to be a defective-product image. For this determination, a support vector machine (SVM) classifier or the like may be used.

FIGS. 3C to 3E are assembly-process images (lower side of FIG. 3C) acquired when any change has occurred in a product, and schematic diagrams (upper side of FIG. 3C) of the images. FIG. 3F is a diagram illustrating distribution of features of each assembly-process image. When the change is small as in FIG. 3C, the features are positioned inside the evaluation area. In such a case, the assembly-process image is determined to be a non-defective-product image, and therefore it is determined that no anomaly has occurred in the product. In contrast, when the changes are large as in FIG. 3D and FIG. 3E, the features are positioned outside the evaluation area. In such cases, the assembly-process image is determined to be a defective-product image, and therefore it is determined that an anomaly has occurred in the product.

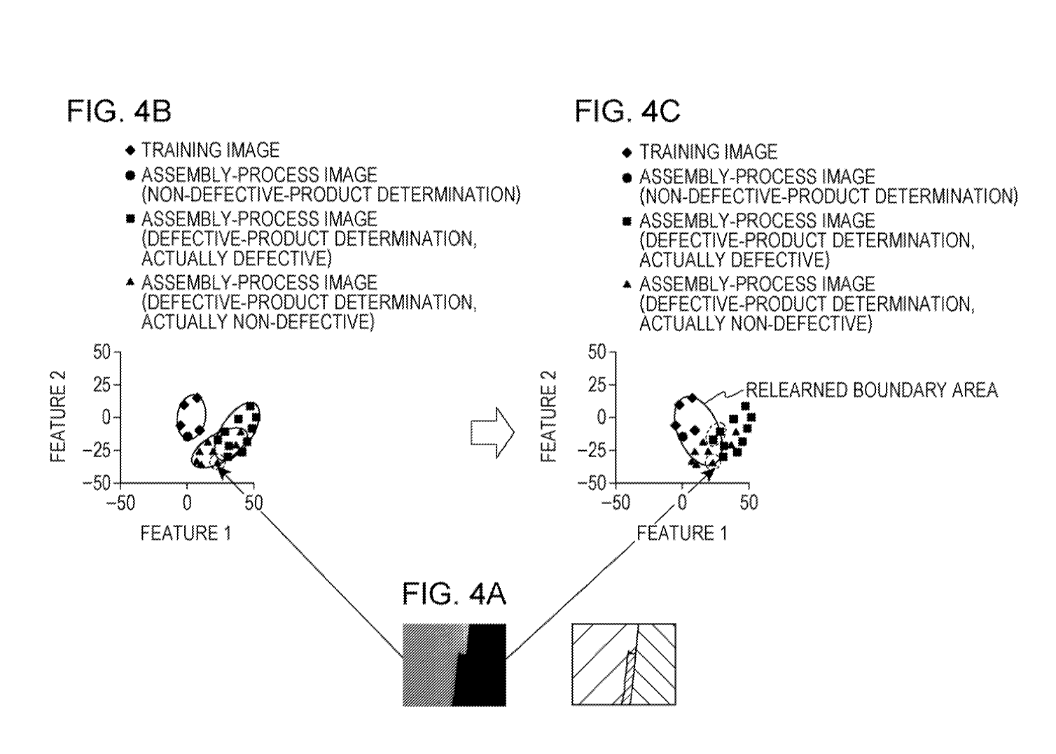

A non-defective-product image is included among assembly-process images that were not expected at the time of developing an image recognition algorithm. FIG. 4A illustrates an example of a non-defective-product image (upper side) of the case where although an external change is depicted in the image, no anomaly has occurred in the product, and a schematic diagram (lower side) of the image. Even such a non-defective-product image is incorrectly determined to be a defective-product image if this image is positioned outside the evaluation area as illustrated in FIG. 4B. The evaluation area is to be relearned by using the assembly-process image incorrectly determined to be a defective-product image so that the image incorrectly determined to be a defective image is determined to be a non-defective-product image. In such a case, the evaluation area is relearned based on feature 1 and feature 2.

FIG. 4C is a diagram illustrating an updated evaluation area. As illustrated in FIG. 4C, the evaluation area, including the initial evaluation area, is expanded. Expansion of the evaluation area results in that the non-defective-product image of FIG. 4A is determined to be a non-defective image. However, because of expansion of the evaluation area, there is a possibility that a defective-product image is also incorrectly determined to be a non-defective-product image.

In embodiments described hereinafter, an image inspection apparatus, an image inspection method, and an image inspection program that may reduce incorrect determinations will be described.

### First Embodiment

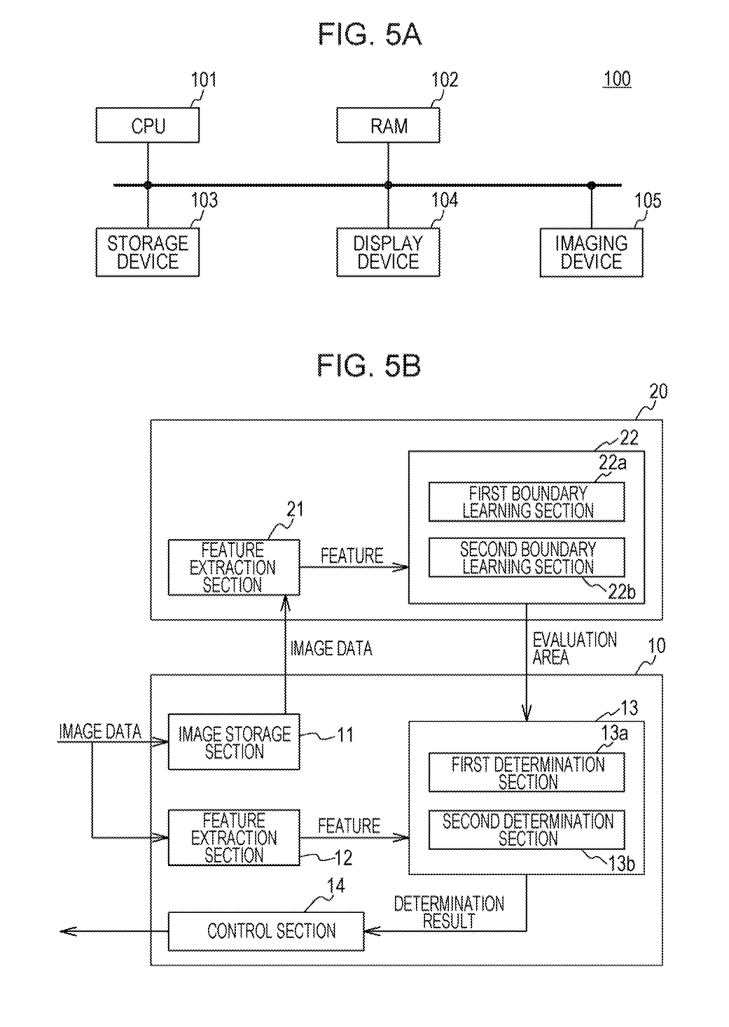

FIG. 5A is a block diagram illustrating a hardware configuration of an image inspection apparatus 100 of a first embodiment. As illustrated in FIG. 5A, the image inspection apparatus 100 includes a CPU 101, a random access memory (RAM) 102, a storage device 103, a display device 104, an imaging device 105, and the like. The imaging device may have an image sensor. These devices are each coupled by a bus or the like. The CPU 101 is a central processing unit. The CPU 101 includes one or more cores. A CPU is sometimes called a processor. The RAM 102 is a volatile memory that temporarily stores a program that is executed by the CPU 101, data that is processed by the CPU 101, and the like. The storage device 103 is a nonvolatile storage device. As the storage device 103, for example, a read-only memory (ROM), a solid state drive (SW) such as a flash memory, a hard disk that is driven by a hard disk drive, or the like may be used. The display device 104 is a liquid crystal display, an electro-luminescent panel, or the like, and displays a determination result. The imaging device 105 is a device that acquires an image of a product halfway through the product assembly process.

FIG. 5B is a functional block diagram of the image inspection apparatus 100. As illustrated in FIG. 5B, a determination section 10 and a learning section 20 are implemented by the CPU 101 executing a program stored in the storage device 103. The determination section 10 includes an image storage section 11, a feature extraction section 12, a determination section 13, a control section 14, and the like. Note that, the determination section 13 includes a first determination section 13a and a second determination section 13b. The learning section 20 includes a feature extraction section 21, a boundary learning section 22, and the like. The boundary learning section 22 includes a first boundary learning section 22a and a second boundary learning section 22b. Note that each of these sections may be hardware such as a circuit for exclusive use.

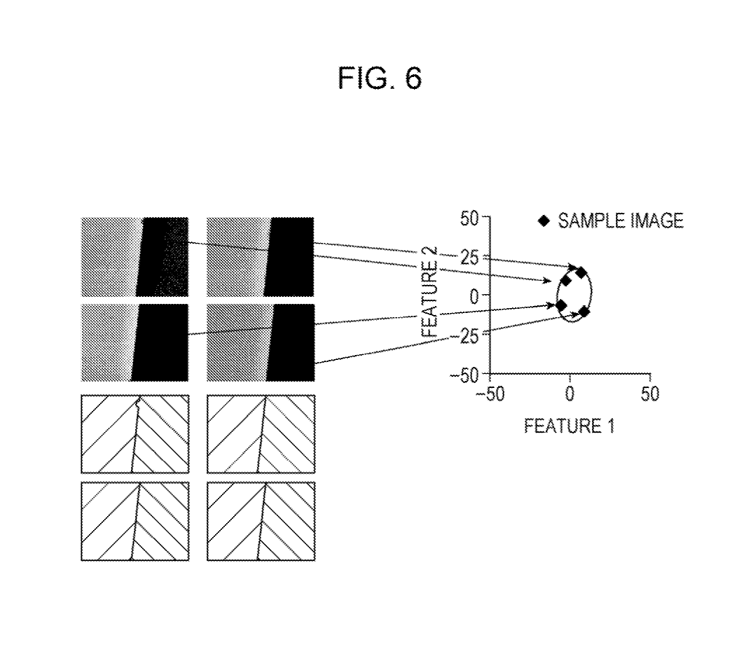

In the image inspection apparatus 100, a first evaluation area is set. First, the first evaluation area will be described. Before the actual product assembly process begins, a plurality of sample images acquired by the imaging device 105 are stored as images for learning in the image storage section 11. The feature extraction section 21 extracts features from each sample image (a first image) stored in the image storage unit 11. The first boundary learning section 22a uses these features to learn a first boundary, and thus outputs first evaluation area data. For example, as illustrated with each sample image (upper side) and a schematic diagram (lower side) thereof in FIG. 6, features are extracted from each sample image. In the example in FIG. 6, as the features, a contrast (feature 1) and an average luminance (feature 2) are used. In the example in FIG. 6, feature 1 and feature 2 are used as first evaluation parameters.

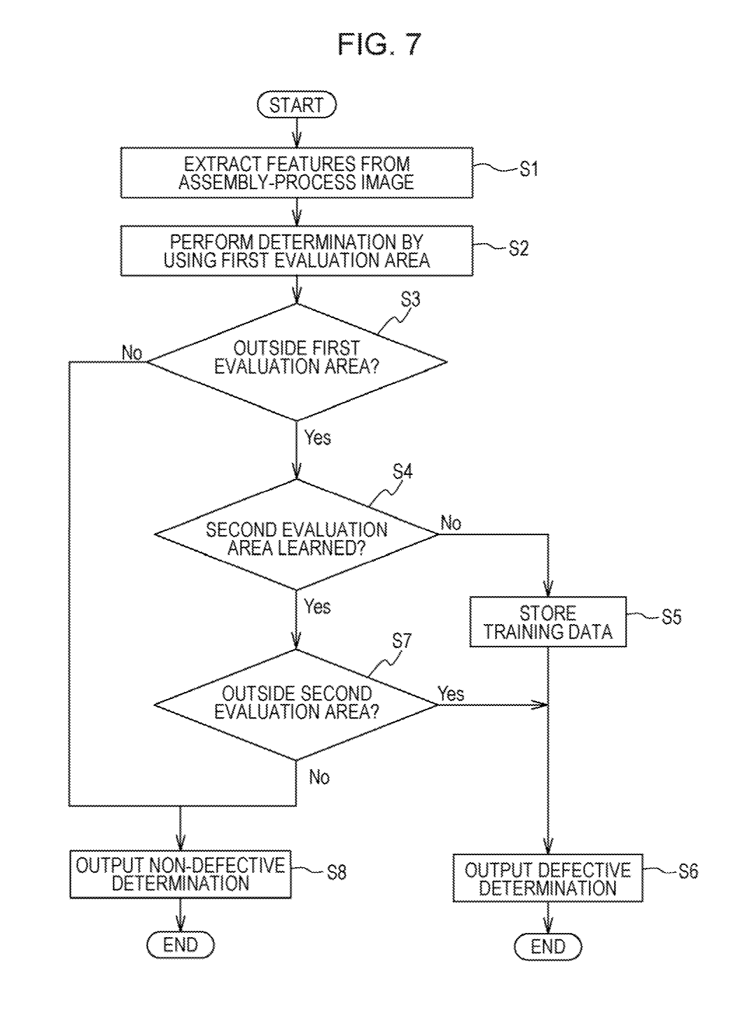

FIG. 7 is a diagram illustrating a flowchart that is executed when the image inspection apparatus 100 inspects an image. Hereinafter, with reference to FIG. 5B and FIG. 7, operations of the image inspection apparatus 100 will be described.

As a product assembly process begins, the image storage section 11 stores an assembly-process image (a second image) acquired by the imaging device 105. The feature extraction section 12 extracts features from the assembly-process image stored in the image storage section 11 (step S1). Next, the first determination section 13a performs determination using the first evaluation area (step S2). The first determination section 13a determines whether the assembly-process image is positioned outside the first evaluation area (step S3). If the determination result is “No” in step S3, the control unit 14 outputs information representing that this image is determined to be a non-defective-product image (step S8). Thereby, the display device 104 gives a display indicating that the determined assembly-process image is a non-defective-product image.

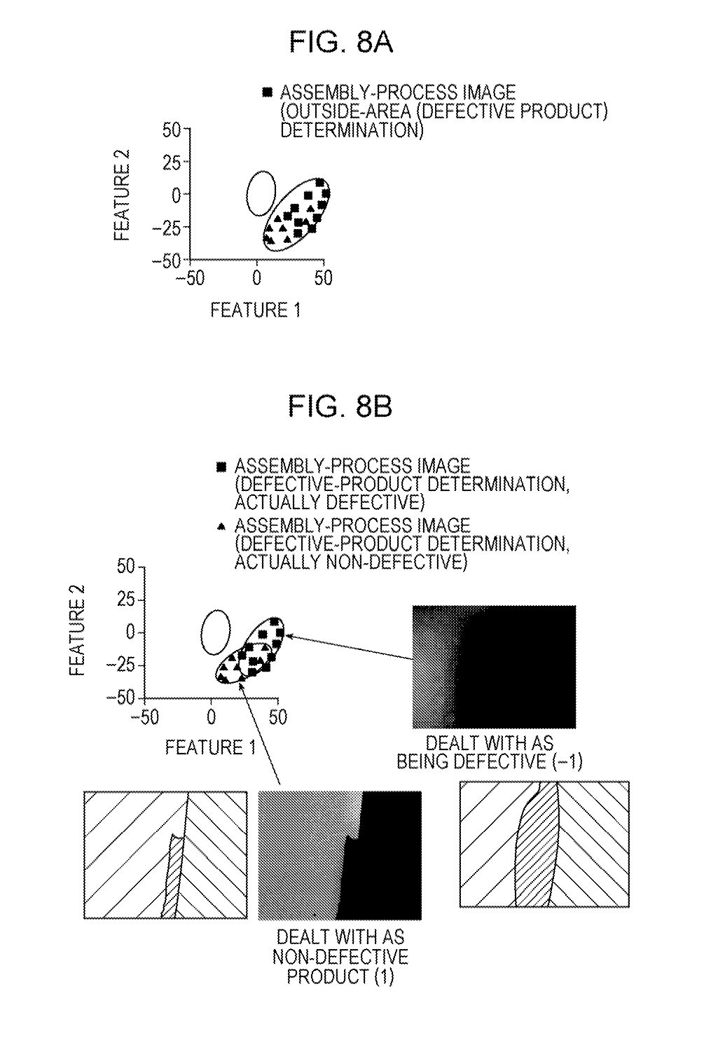

If the determination result in step S3 is “Yes”, the control section 14 determines whether a second evaluation area has been learned (step S4). If the determination result in step S4 is “No”, the user visually verifies whether the assembly-process image is a non-defective-product image or a defective-product image, and uses an input device such as a keyboard or a mouse to add, to this assembly-process image, an identifier for identifying which of the two images this assembly-process image is. The image storage unit 11 stores, as an image for learning, the assembly-process image with the added identifier (step S5). The image with the added identifier is referred to as training data hereinafter. For example, as illustrated in FIG. 8A, an assembly-process image positioned outside the first evaluation area is determined to be a defective-product image. As illustrated with assembly-process images (middle-right and lower sides)and schematic diagrams (lower side) thereof in FIG. BB, among these assembly-process images, some images determined by the user to be non-defective images are given “1” whereas some images determined by the user to be defective-product images are given “−1”. Note that the control unit 14 outputs information representing that the assembly-process image has been determined to be a defective-process image (step S6). Thereby, the display device 104 gives a display indicating that the determined assembly-process image is a defective-process image.

If the determination result in step S4 is “Yes”, the second determination section 13b makes a determination using the second evaluation area to determine whether the assembly-process image is positioned outside the second evaluation area (step S7). If the determination result in step S7 is “No”, the control section 14 outputs information representing that the assembly-process image has been determined to be a non-defective image (step S8). Thereby, the display device 104 gives a display indicating that the determined assembly-product image is a non-defective image. If the determination result in step S7 is “Yes”, step S6 is executed.

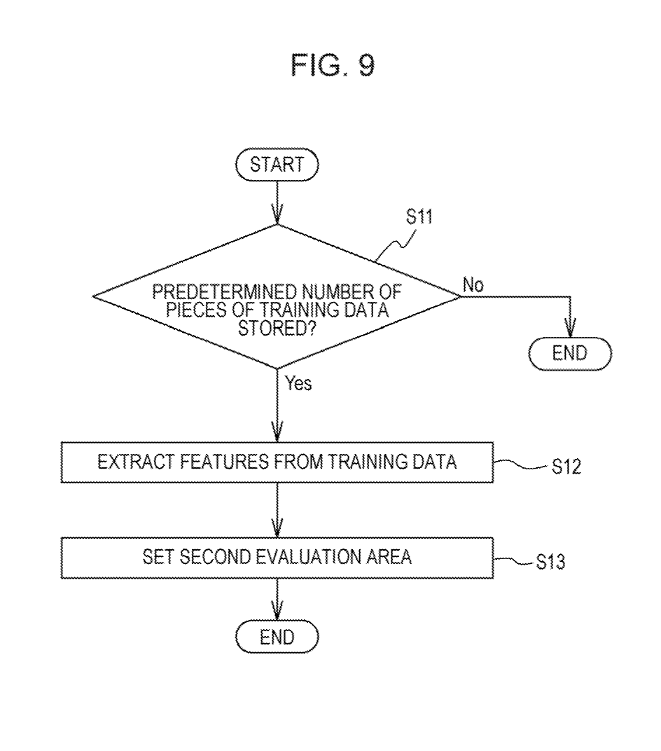

FIG. 9 is a diagram illustrating a flowchart that is executed parallel to the flowchart in FIG. 7. The flowchart in FIG. 9 is executed, for example, each time step S5 in FIG. 7 is executed. As illustrated in FIG. 9, the second boundary learning section 22b determines whether a predetermined number of (for example, 100) pieces of training data have been stored in the image storage section 11 (step S11). If the determination result in step S11 is “No”, execution of the flowchart ends. If the determination result in step S11 is “Yes”, the feature extraction section 21 extracts features from the training data stored in the image storage section 11 (step S12). Next, the second boundary learning section 22b learns a second boundary to set the second boundary area (step S13). Then, the execution of the flowchart ends.

Note that it may be determined in step S11 whether a predetermined number of non-defective-product images of training data (training data that is determined by the user to be non-defective-product images while having been determined in step S3 by the first determination section 13a to be defective-product images) have been stored. When the determination accuracy of the first determination section 13a is high, the learning frequency of the second determination section 13b may be reduced. In step S13, only non-defective-product images of training data (training data that is determined by the user to be non-defective-product images while having been determined in step S3 by the first determination section 13a to be defective-product images) may be learned. Carefully selecting training data to be learned may reduce the load of learning on the second determination section 13b.

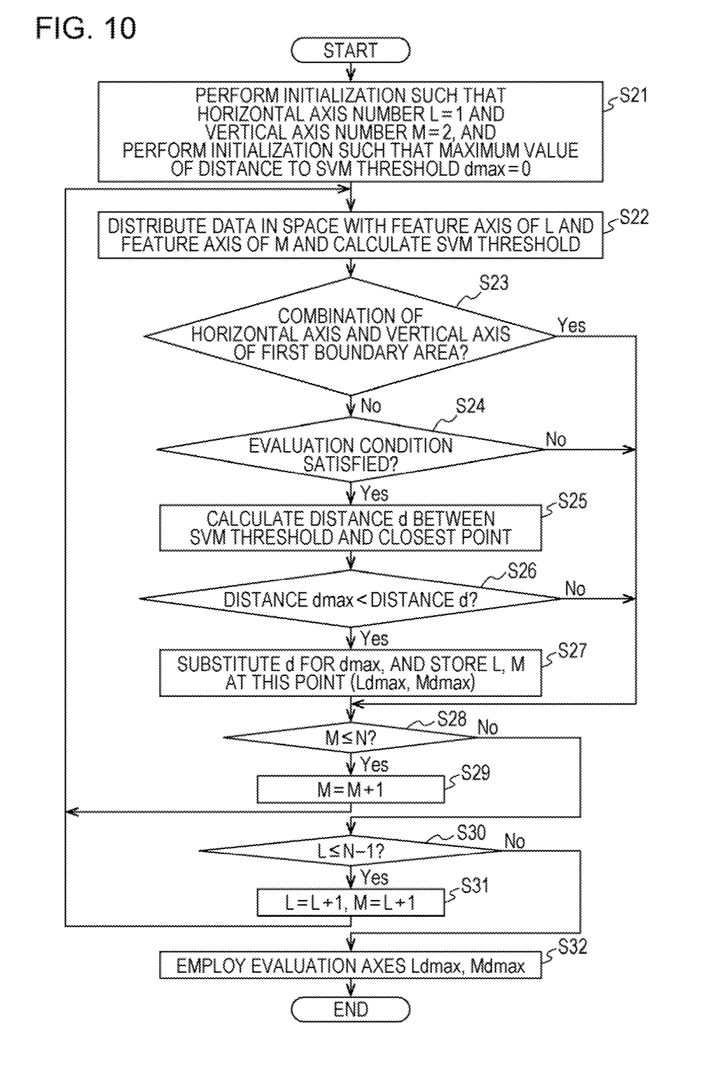

FIG. 10 is a diagram illustrating a flowchart representing the details of step S13. As illustrated in FIG. 10, the second boundary learning section 22b initializes a feature horizontal-axis number L to “1” and initializes a feature vertical-axis number M to “2”. The second boundary learning section 22b also initializes a maximum value dmax of the distance to the SVM threshold (the boundary of the second evaluation area) to “0” (step S21). Note that N-dimensional feature data is assumed to have been extracted from each training data. As examples of evaluation axis data, feature 1 is assumed to be the axis of average luminance data, feature 2 is assumed to be the axis of contrast data, feature 3 is assumed to be the axis of histogram data, feature 4 is assumed to be the axis of frequency information data, and so on.

Next, the second boundary learning section 22b distributes training data stored in the image storage section 11 in the space with a feature axis L and a feature axis M to calculate an SVM threshold (step S22). In this case, the feature axis L and the feature axis M are examples of a second evaluation parameter. In addition, the SVM threshold is an example of a second evaluation criterion. Next, the second boundary learning section 22b determines whether a combination of the feature axis L and the feature axis M is a combination of the horizontal axis and the vertical axis of the first evaluation area (step S23).

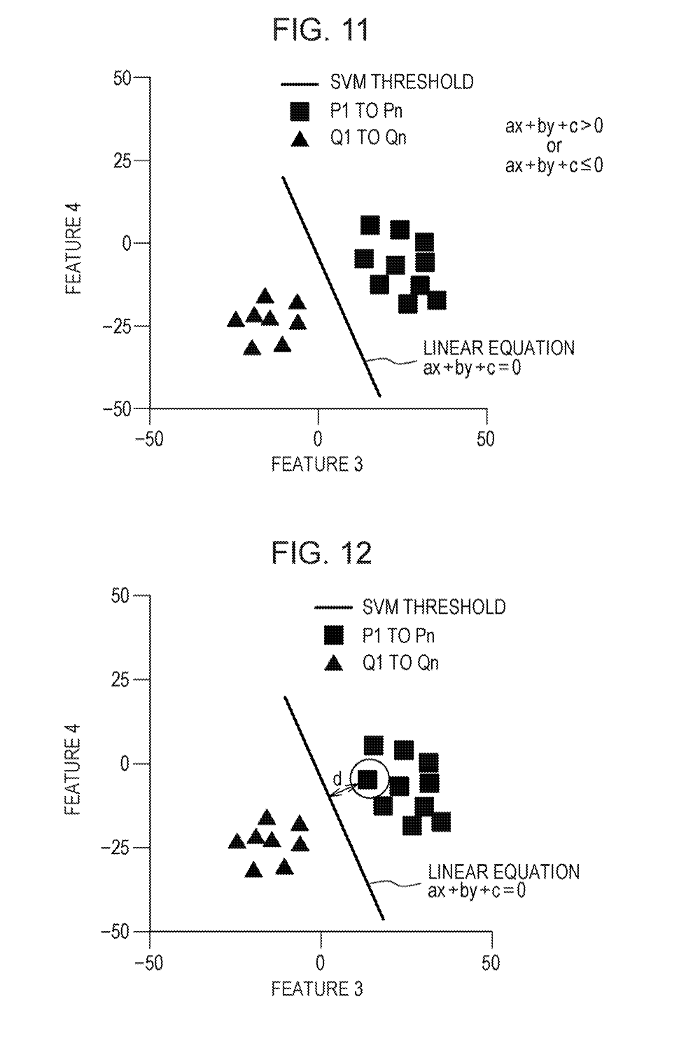

If the determination result in step S23 is “No”, the second boundary learning section 22b determines whether the combination of the feature axis L and the feature axis M satisfies evaluation conditions (step S24). FIG. 11 is a diagram illustrating evaluation conditions. When an SVM threshold is determined for, among training data, data (P1 to Pn) that the user has determined to be non-defective-product images and data (Q1 to Qn) that the user has determined to be defective-product images, the SVM threshold is a linear equation that may be represented as ax+by+c=0. Here, “x” is numeric data in the horizontal-axis direction, “y” is numeric data in the vertical-axis direction, and “a”, “b”, and “c” are coefficients. The evaluation conditions are that when the data of P1 to Pn is substituted into the linear equation of the SVM threshold, all the results have the same sign, and when the data of Q1 to Qn is substituted into the linear equation of the SVM threshold, all the results have the same sign that is opposite to that in the case of data of P1 to Pn. By satisfying the evaluation conditions, all of the data of P1 to Pn may be positioned on one side with respect to the linear equation of the SVM threshold, and all of the data of Q1 to Qn may be positioned on the other side with respect to the linear equation of the SVM threshold. That is, by satisfying the evaluation conditions, the data of P1 to Pn and the data of Q1 to Qn may be separate from each other with respect to the linear equation of the SVM threshold.

If the determination result in step S24 is “Yes”, the second boundary learning section 22b calculates a distance d between the SVM threshold and the closest point thereto among points distributed in step 522 (step S25). As illustrated in FIG. 12, among points distributed in step S22, the closest point to the SVM threshold is selected. In addition, the distance d may be calculated according to d=|ax+by+c|/√(a²+b²).

Next, the second boundary learning section 22b determines whether the distance d is greater than the distance dmax (step S26). If the determination result in step S26 is “Yes”, the distance d is substituted for the distance dmax, and the horizontal axis L and the vertical axis M at this point are stored as L_{dmax} and M_{dmax} (step S27).

Next, the second boundary learning section 22b determines whether the vertical axis number M is less than or equal to N (the number of dimensions) (step S28). If the determination result in step S28 is “Yes”, the second boundary learning section 22b adds one to the vertical axis number M (step S29). Then, step 522 and the subsequent steps are executed again. If the determination result in step S28 is “No”, the second boundary learning section 22b determines whether the horizontal axis number L is less than or equal to (N−1) (step S30). If the determination result in step S30 is “Yes”, the second boundary learning section 22b adds one to the horizontal axis number L (step S31). Then, step S22 and the subsequent steps are executed again. If the determination result in step S30 is “No”, the second boundary learning section 22b employs the horizontal axis number L_{dmax} and the vertical axis number M_{dmax} as evaluation axes (step S32). Then, execution of the flowchart ends. Note that if the determination result in step S23 is “Yes”, if the determination result in step S24 is “No”, or if the determination result in step S26 is “No”, step S28 is executed.

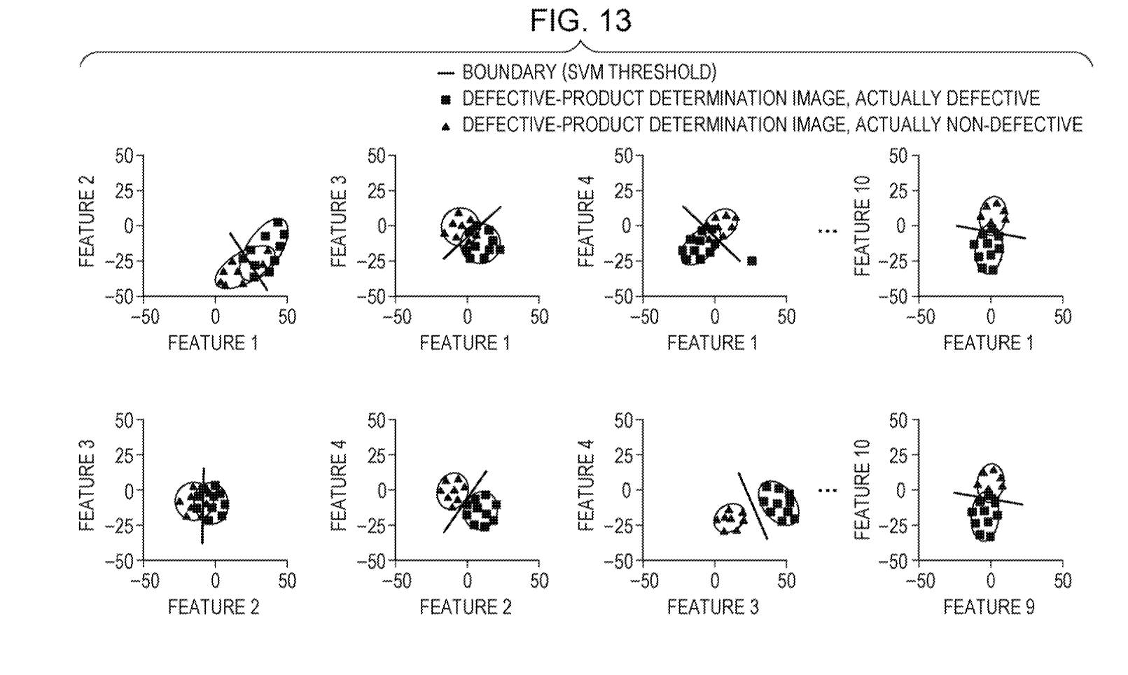

Following the process in FIG. 10, ₁₀C₂=45 combinations are evaluated as illustrated in FIG. 13. Among these combinations, a combination of feature axes with which the distance d between the SVM threshold and the closest point is greatest is employed. In this case, the degree of separation between non-defective-product images and defective-product images in training data with respect to the SVM threshold is highest. In the example in FIG. 13, a combination of feature 3 and feature 4 has the highest degree of separation. Note that, owing to execution of step S13, calculation of the degree of separation is omitted for the same combination as the combination of the horizontal axis and the vertical axis of the first evaluation area. In the example in FIG. 13, calculation of the degree of separation of the combination of feature 1 and feature 2 is omitted.

According to the present embodiment, by using training data (the second image) that is positioned outside the first evaluation area (the first evaluation criterion), which is machine learned based on predetermined feature axes (the first evaluation parameter) by using sample images (the first images), and is thus determined to be a defective-product image, the second evaluation area (the second evaluation criterion) is machine learned based on predetermined feature axes (the second evaluation parameter). In this case, since the second evaluation area is machine learned by using the training data, incorrect determination of an image positioned outside the first evaluation area is reduced. Note that since an image positioned inside the first evaluation area is determined to be a non-defective-product image, the accuracy in determination based on the first evaluation area is maintained.

As illustrated in FIG. 13, it is desirable that a combination of feature axes be selected in accordance with training data. In this case, since a second evaluation area is set by using the selected combination of feature axes, the accuracy improves in a defectiveness determination for an assembly-process image that has been determined in a determination using a first evaluation area to be a defective-product image.

In addition, as described in step S23 in FIG. 10, it is desirable that a combination of the horizontal axis and the vertical axis of a first evaluation area be excluded when a second evaluation area is set. In this case, evaluation parameters for learning of an evaluation area for which training data has been determined to be a defective-product image will not be used. Thereby, the accuracy improves in a defectiveness determination using the second evaluation area.

In addition, as illustrated in FIG. 11, it is desirable that a combination of feature axes be selected such that all of the data of P1 to Pn is positioned on one side with respect to the linear equation of the SVM threshold and all of the data of Q1 to Qn is positioned on the other side with respect to the linear equation of the SVM threshold. In this case, the degree of separation between defective-product images and non-defective-product images improves.

In addition, as illustrated in FIG. 12, it is desirable that a combination of feature axes is selected in accordance with the distance between training data and the SVM threshold. For example, it is desirable that a combination of feature axes be selected such that the distance d between the SVM threshold and the closest point is greatest. In this case, the degree of separation between defective-product images and non-defective-product images improves.

Note that, in the above embodiment, attention is paid to images of products in an assembly process; however, objects for which it is determined whether an image depicts defectiveness or non-defectiveness are not limited to the products in the assembly process.

Note also that, in the above embodiment, the feature axes used for learning are two (two-dimensional) axes; however, the present disclosure is not limited to this. For example, three- or more- (three- or more-dimensional) feature axes may be used for learning. In this case, the SVM threshold is not a linear equation but is a plane or the like.

In the above embodiment, the first determination section 13a functions as an example of a first determination section that determines whether a second image depicts defectiveness or non-defectiveness, based on a first evaluation criterion learned by using a first evaluation parameter of a first image. The second determination section 13b functions as an example of a second determination section that when the first determination section determines that the second image depicts defectiveness, determines whether the second image depicts defectiveness or non-defectiveness, based on a second evaluation criterion learned by using a second evaluation parameter. The second boundary learning section 22b functions as an example of a learning section that learns the second evaluation criterion by using the second evaluation parameter of an image determined by the first determination section to depict defectiveness.

### Other Embodiments

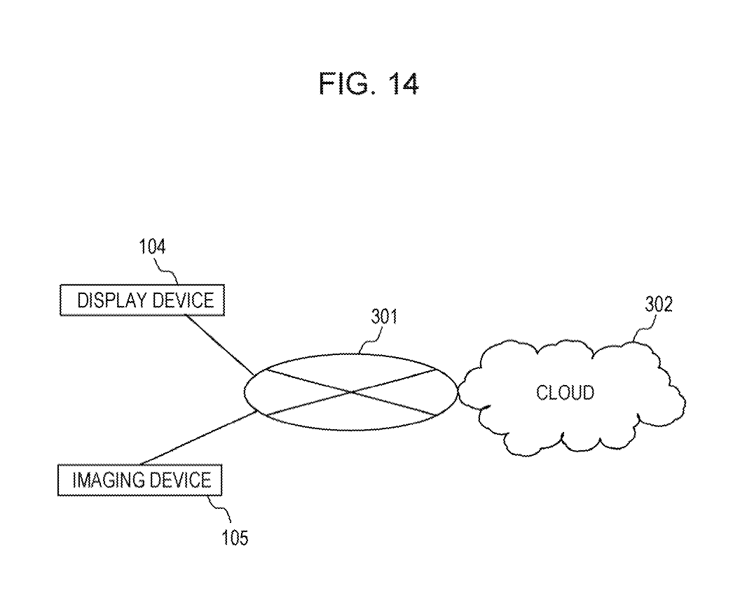

FIG. 14 is a diagram illustrating an image inspection system. As illustrated in FIG. 14, the image inspection system has a configuration in which the display device 104 and the imaging device 105 are coupled through an electric communication line 301, such as the Internet, to a cloud 302. The cloud 302 includes the CPU 101, the RAM 102, the storage device 103, and the like in FIG. 5A, and implements the functions of the determination section 10 and the learning section 20. In the image inspection system in such a manner, for example, an image acquired by the imaging device 105 is received via the electric communication line 301 by the cloud 302, where machine learning and determination of whether an image depicts defectiveness or non-defectiveness are performed. Note that, instead of the cloud 302, a server coupled via an intranet or the like may be used.

Although the embodiments of the present disclosure have been described above, the present disclosure is not limited to such specific embodiments, and various modifications and changes may be made without departing from the spirit and scope of the present disclosure as defined in the claims.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An image inspection apparatus comprising
a processor configured to:
determine whether a second image depicts defectiveness or non-defectiveness, based on a first evaluation criterion learned by using a first evaluation parameter of a first image, and
when the processor determines that the second image depicts defectiveness, determine whether the second image depicts defectiveness or non-defectiveness, based on a second evaluation criterion learned by using a second evaluation parameter.

2. The image inspection apparatus of claim 1, wherein the first image and the second image are images of a package on which a component is mounted.

3. The image inspection apparatus of claim 2, wherein the first evaluation criterion and the second evaluation criterion are features of an image positioned inside or outside an evaluation area set for an image of the package.

4. The image inspection apparatus of claim 3, wherein the features include at least one of an average luminance, a luminance distribution, a contrast, and frequency information.

5. The image inspection apparatus of claim 1, wherein the processor is configured to learn the second evaluation criterion by using the second evaluation parameter of an image determined to depict defectiveness.

6. The image inspection apparatus of claim 5, wherein the second evaluation parameter is selected in accordance with an image determined by the processor to depict defectiveness.

7. The image inspection apparatus of claim 5, wherein the first evaluation parameter is excluded when the processor selects the second evaluation parameter.

8. The image inspection apparatus of claim 3, wherein whether the second image depicts defectiveness or non-defectiveness indicates that mounting of the component on the package is determined.

9. The image inspection apparatus of claim 5, wherein
there are a plurality of images used in learning the second evaluation criterion,
an identifier representing “defective” or “non-defective” is attached to each of the plurality of images, and
the processor is configured to
select the second evaluation parameter such that an image to which “defective” is attached and an image to which “non-defective” is attached are on opposite sides of a boundary of the second evaluation criterion.

10. The image inspection apparatus of claim 9, wherein the processor is configured to select the second evaluation parameter in accordance with a distance between the second image and the boundary.

11. The image inspection apparatus of claim 1, further comprising a camera, wherein the first and second images are imaged by using the camera.

12. An image inspection method performed by a computer, the image inspection method comprising:
determining whether a second image depicts defectiveness or non-defectiveness, based on a first evaluation criterion learned by using a first evaluation parameter of a first image, and
when the processor determines that the second image depicts defectiveness, determining whether the second image depicts defectiveness or non-defectiveness, based on a second evaluation criterion learned by using a second evaluation parameter.

13. A non-transitory, computer-readable recording medium having stored therein a program for causing a computer to execute a process, the process comprising:
determining whether a second image depicts defectiveness or non-defectiveness, based on a first evaluation criterion learned by using a first evaluation parameter of a first image; and
when the processor determines that the second image depicts defectiveness, determining whether the second image depicts defectiveness or non-defectiveness, based on a second evaluation criterion learned by using a second evaluation parameter.
